(19) United States
(12) Patent Application Publication
(10) Pub. No.: US 2024/0253745 A1
(43) Pub. Date: Aug. 1, 2024

(54) BOAT SEATING

(71) Applicant: Polaris Industries Inc., Medina, MN (US)

(72) Inventors: Blair A. Donat, Osceola, IN (US); Victor B. Garcia, Granger, IN (US)

(73) Assignee: Polaris Industries Inc., Medina, MN (US)

(21) Appl. No.: 18/406,710

(22) Filed: Jan. 8, 2024

Related U.S. Application Data
(60) Provisional application No. 63/441,535, filed on Jan. 27, 2023.

(51) Int. Cl. B63B 29/04

(52) U.S. Cl. CPC B63B 29/04; B63B 2029/043

(57) ABSTRACT

In some examples, a seat for a boat passenger is provided. The seat includes a seat back that has a forward passenger support interface. The seat back includes a main support and a supplemental support. The main support has a recess. The supplemental support is moveable relative to the main support between a first position wherein a first portion of the supplemental support forms part of the forward passenger support interface and a second position wherein a second portion of the supplemental support forms part of the forward passenger support interface. At least a portion of the supplemental support is received in the recess of the main support in the first position and is spaced apart from the recess in the second position.

### CROSS-REFERENCE TO RELATED APPLICATIONS

The present application claims priority to U.S. Provisional Application No. 63/441,535, filed on Jan. 27, 2023, and entitled “BOAT SEATING,” the entire disclosure of which is expressly incorporated by reference herein.

### TECHNICAL FIELD

The present application relates generally to seats, and more specifically, to seats that may be used for boat passengers.

### BACKGROUND

Seats may be used in a variety of contexts. Exemplary seats include, bucket seats, bench seats, and chaises to support boat passengers who are sitting or reclining thereon.

### SUMMARY

Aspects of the present disclosure relate generally to a seat, such as a seat for a boat passenger. The seat may have a seat back that includes a main support having a recess and a supplemental support that flips up from the recess of the main support.

In some examples, a seat for a boat passenger is provided. The seat includes a seat back that has a forward passenger support interface. The seat back includes a main support and a supplemental support. The main support has a recess. The supplemental support is moveable relative to the main support between a first position wherein a first portion of the supplemental support forms part of the forward passenger support interface and a second position wherein a second portion of the supplemental support forms part of the forward passenger support interface. At least a portion of the supplemental support is received in the recess of the main support in the first position and is spaced apart from the recess in the second position.

Some examples further include a seat bottom that has an upper passenger support interface that is sized and shaped to support legs and feet of the boat passenger.

In some examples, the main support includes a center portion, and laterally opposed support members, the center portion extends between the laterally opposed support members, and the recess is formed between the laterally opposed support members.

In some examples, the main support defines a top edge and a bottom edge. The recess extends at least partially between the top edge and the bottom edge of the main support.

In some examples, the supplemental support is rotatable between the first position and the second position, with respect to the main support.

Some examples further include hinges, by which the supplemental support is coupled to the main support, and about which the supplemental support rotates.

In some examples, the hinges are one of friction hinges or detent hinges.

In some examples, the supplemental support is translatable between the first position and the second position.

In some examples, the supplemental support comprises at least one of a strap, a grip, or a handle.

In some examples, a seat for a boat passenger is provided. The seat includes a seat bottom and a seat back. The seat bottom has an upper passenger support interface that is sized and shaped to support legs and feet of the boat passenger. The seat back has a forward passenger support interface. The seat back includes a main support and a supplemental support. The main support has a lower extent and an upper extent. The supplemental support is moveable relative to the main support between a first position and a second position. In the first position, a first portion of the supplemental support is positioned lower than a top edge of the upper extent of the main support. In the second position, the first portion of the supplemental support is positioned higher than the upper extent of the main support.

In some examples the main support further includes a bottom edge. The recess extend at least partially between the top edge and the bottom edge of the main support.

In some examples, a seat for a boat passenger is provided. The seat includes a seat bottom and a seat back. The seat bottom has an upper passenger support interface that is sized and shaped to support legs and feet of the boat passenger. The seat back has a forward passenger support interface. The seat back includes a main support and a supplemental support. The supplemental support is moveable relative to the main support between a first position wherein the supplemental support forms a back support and a second position wherein the supplemental support forms a head support.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 illustrates a front, top, and right-side view of an example pontoon boat, according to some aspects described herein.

FIG. 2A illustrates a front view of a seat for a boat passenger, in a first configuration, according to some aspects described herein.

FIG. 2B illustrates a front view of the seat of FIG. 2A, in a second configuration, according to some aspects described herein.

FIG. 3A illustrates a right-side view of the seat of FIG. 2A, in the first configuration, according to some aspects described herein.

FIG. 3B illustrates a right-side, cross-sectional view of the seat of FIG. 2A, in the first configuration, according to some aspects described herein.

FIG. 3C illustrates a right-side, cross-sectional view of the seat of FIG. 2A, in the first configuration, according to some aspects described herein.

FIG. 4A illustrates a right-side view of the seat of FIG. 2A, in the second configuration, according to some aspects described herein.

FIG. 4B illustrates a right-side, cross-sectional view of the seat of FIG. 2A, in the second configuration, according to some aspects described herein.

FIG. 4C illustrates a right-side, cross-sectional view of the seat of FIG. 2A, in the second configuration, according to some aspects described herein.

FIG. 5 illustrates an exploded view of components of the seat of FIG. 2A, according to some aspects described herein.

Corresponding reference characters may indicate corresponding parts throughout the several views. Unless stated otherwise the drawings are proportional and drawn to scale.

### DETAILED DESCRIPTION OF THE DRAWINGS

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

While the structures and components disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated. Further, throughout the disclosure, the terms “about”, “substantially”, and “approximately” mean plus or minus 5% of the number or geometric constraint that each term precedes. For example, about 100 may mean 100+/5. Additionally, or alternatively, substantially orthogonal may mean that any 90 degree angle related to the described orthogonality may be between 85.5 degrees and 94.5 degrees (inclusive).

As mentioned above, seats may be used in a variety of contexts. An exemplary seat may be used as a boat chaise to support boat passengers who are sitting or lying thereon. However, when a boat passenger is on a conventional boat chaise, they may not be provided with adequate head support. Specifically, in some examples, the boat passenger may not be provided with adequate head support unless they are lying low enough on the boat chaise.

In embodiments disclosed herein, a head and/or neck support is provided to a boat passenger who is in a sitting position on a boat seat (e.g., a boat chaise), via a component of the seat. In embodiments disclosed herein, the head and/or neck support is stored within a remainder of the seat, while the head and/or neck support is not being used.

In embodiments, a seat for a boat passenger is provided. The seat may include a seat bottom that is sized and shaped to support legs and feet of the boat passenger (e.g., a seat bottom of a boat chaise) and a seat back that has a forward passenger support interface. The seat back may include a main support and a supplemental support that is movable (e.g., rotatable) relative to the main support between a first position and a second position. In the first position, a first part of the supplemental support may form part of the forward passenger support interface, and in the second position, a second portion of the supplemental support interface may form part of the forward passenger support interface. For example, the supplemental support may rotatably flip upward from being part of a back support to instead being a head support.

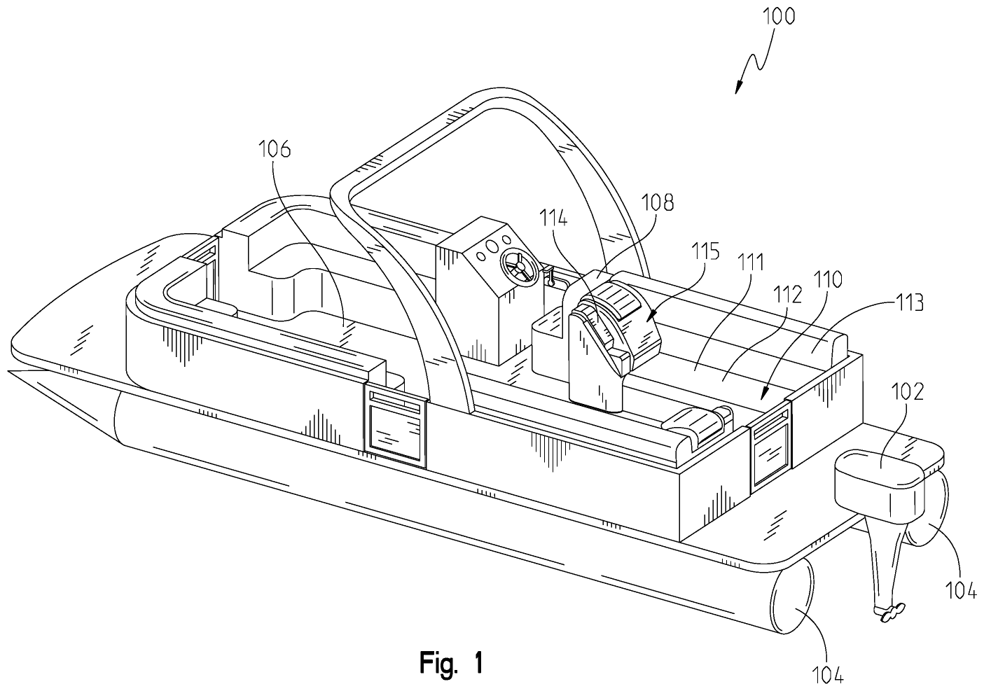

FIG. 1 illustrates a front, top, and right-side view of an example pontoon boat 100, according to some aspects described herein. The pontoon boat 100 includes one or more motors 102, a plurality of pontoons 104, a deck 106, an operator seat 108, and one or more seats for boat passengers (e.g., passenger seats) 110. Additional and/or alternative components that may be part of a pontoon boat, such as the pontoon boat 100, will be recognized by those of ordinary skill in the art. Further, it should be noted that while aspects of the present disclosure are described with respect to a pontoon boat, such aspects are not limited to a pontoon boat and may be applied to, for example, other types of boats or vehicles or free-standing seats.

In some examples, at least some of the passenger seats 110 define chaises or benches, at least in part. The passenger seats 110 include a seat bottom 111 that has an upper passenger support interface 112. The upper passenger support interface 112 may be sized and shaped to support legs and feet of a passenger. For example, the upper passenger support interface 112 may be about 5 feet long, or about 6 feet long, or about 7 feet long, or about 8 feet long. Generally, the upper passenger support interface 112 may be long enough to support the legs, feet, and/or body of the passenger, such that they may lay across the upper passenger support interface.

In some examples, at least some of the passenger seats 110 include a seat side 113. The seat side 113 may extend a length of the seat bottom 111. Alternatively, the seat side 113 may extend along a portion of a length of the seat bottom 111. The seat side 113 may support the side of a passenger when they are laying across the seat bottom 111. Alternatively, in some examples, the seat side 113 may support the back of a passenger, such as when the passenger is sitting upright (e.g., when the lower legs and/or feet of the passenger are not positioned on the seat bottom 111). The seat side 113 and the seat bottom 111 of the passenger seats 110 may define chaises or benches.

In some examples, the passenger seat 110 may include one or more armrests 114. The armrest 114 may be adjustable or fixed to a specific location. The passenger seat 110 may further include cupholders (not shown). For example, the cupholders may be disposed in the armrest 114, the seat bottom 111, and/or the seat side 113. In some examples, the passenger seat 110 may further include a footrest (not shown). The footrest may be adjustable or fixed to a specific location. The passenger seat 110 may further include lights, such as light-emitting diode (LED) lights (not shown). Additional and/or alternative components that may be part of the passenger seat 110 will be recognized by those of ordinary skill in the art.

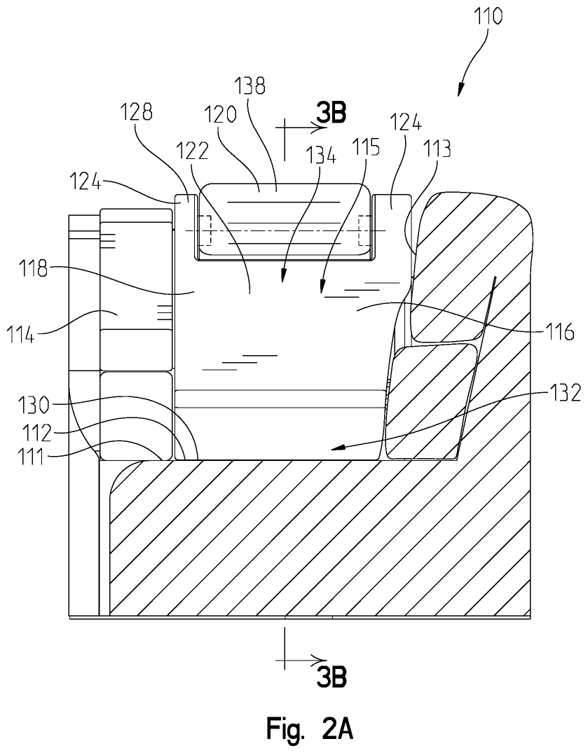

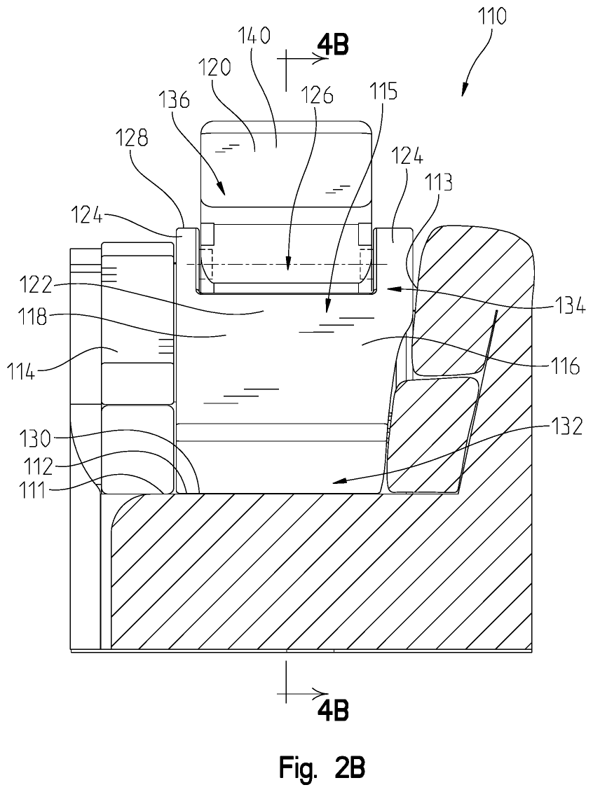

FIG. 2A illustrates a front view of the passenger seat 110, in a first configuration. The passenger seat 110 includes a seat back 115 that has a forward passenger support interface 116. The seat back 115 also includes a main support 118 and a supplemental support 120. In the first configuration, the supplemental support 120 is in a first or down position.

In some examples, the main support 118 includes a center portion 122 and laterally opposed support members 124. The support members 124 may be positioned on opposing sides of the center portion 122. Further, the center portion 122 may extend between the laterally opposed support members 124. A recess 126 may be formed between the laterally opposed support members 124, as will be discussed in further detail later herein.

The main support 118 may define a first or top edge 128 and a second or bottom edge 130. The top edge 128 may be an uppermost edge of the laterally opposed support members 124. The bottom edge 130 may be a bottommost edge of the center portion 122 or laterally opposed support members 124 (e.g., extending along the seat bottom 111).

The main support 118 may have a lower extent 132 and an upper extent 134. The lower extent 132 may include the bottommost point of the main support 118. In some examples, the lower extent 132 may include the lower half or lower quarter of the main support 118. In some examples, the lower extent 132 may be in contact with the seat bottom 111. In some examples, the lower extent 132 may be spaced apart from the seat bottom 111, but adjacent to the seat bottom 111. The upper extent 134 may include be the topmost point of the main support 118. In some examples, the upper extent 134 may include the upper half or upper quarter of the main support 118. The upper extent 134 and the lower extent 132 may be generally opposite of each other across the main support 118.

In some examples, the main support 118 may include at least one of vinyl, leather, nylon, or polyester. In some examples, the supplemental support 120 may include at least one of vinyl, leather, nylon, or polyester. In some examples, the main support 118 and the supplemental support 120 may include at least one of the same material. In some examples, the main support 118 and the supplemental support main include at least one different material. Furthermore, additional and/or alternative materials that may be used for a seat, such as one or more aspects of the passenger seat 110, may be recognized by those of ordinary skill in the art.

FIG. 2B illustrates a front view of the passenger seat 110 of FIG. 2A, in a second configuration. In the second configuration, the supplemental support 120 is in a second or raised position. As shown with respect to FIGS. 2A and 2B, the supplemental support 120 is moveable relative to the main support 118 between the first position and the second position.

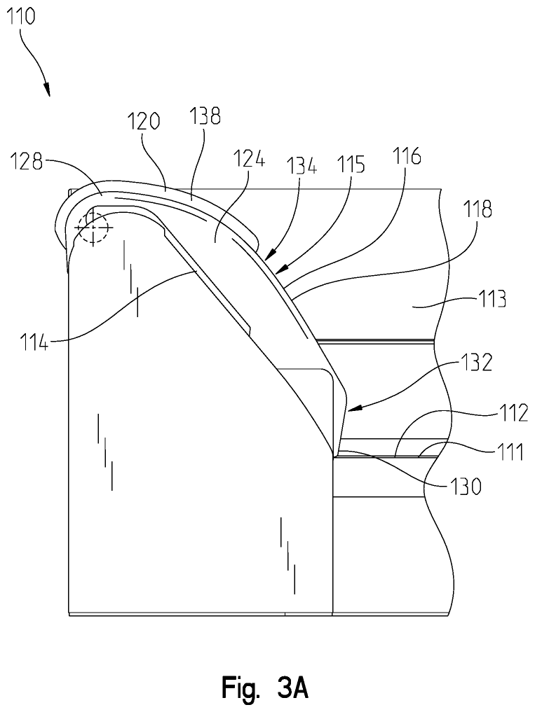

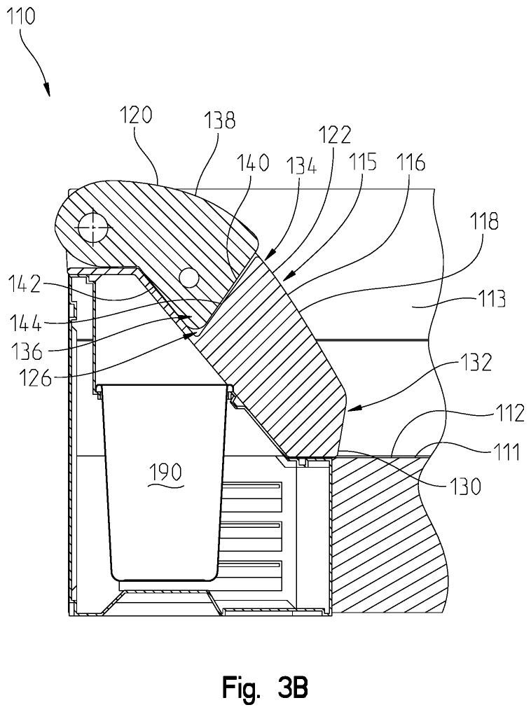

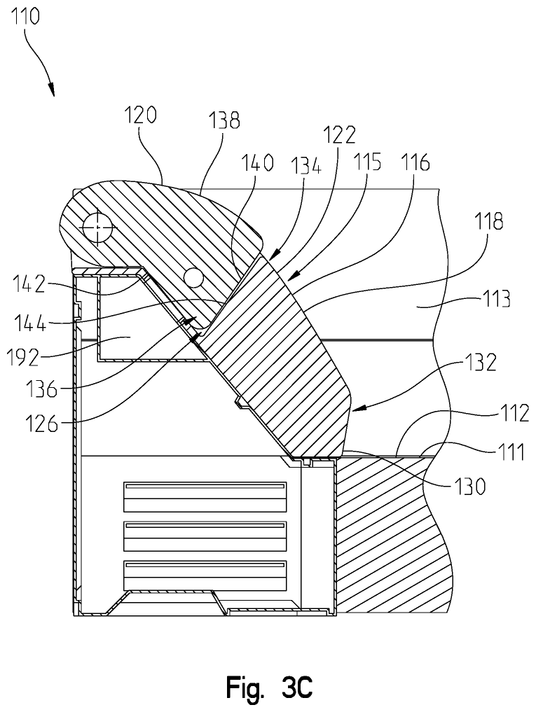

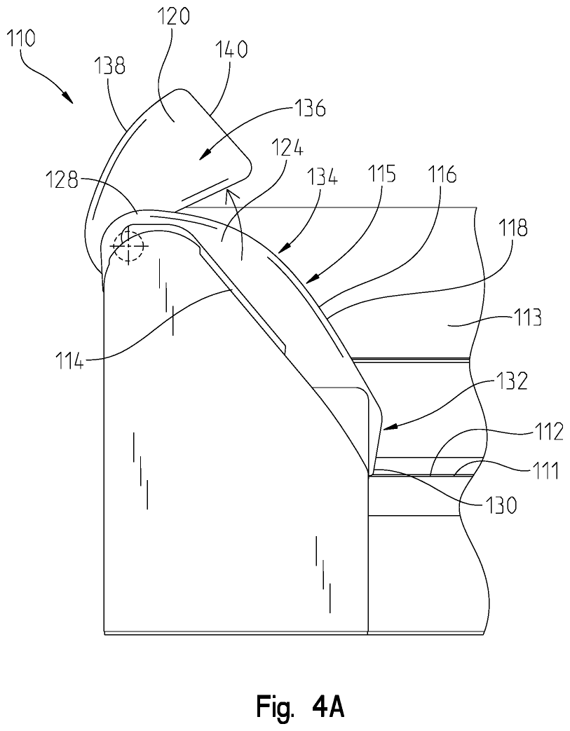

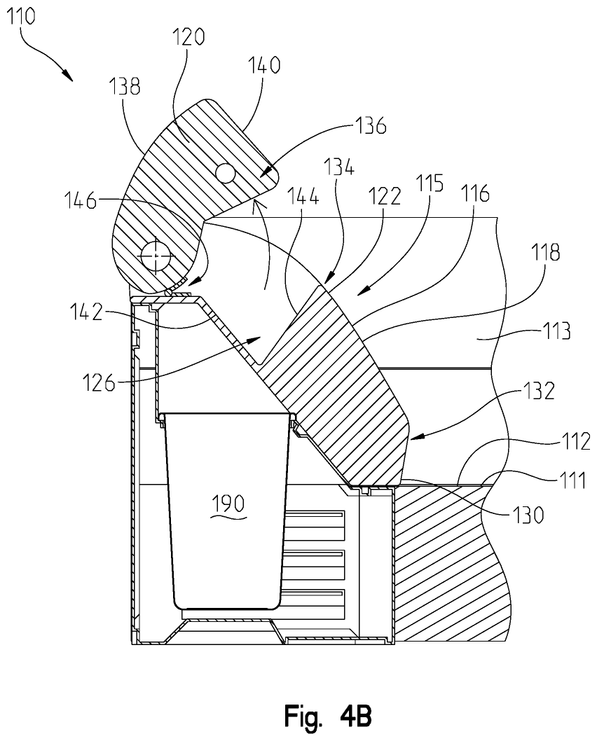

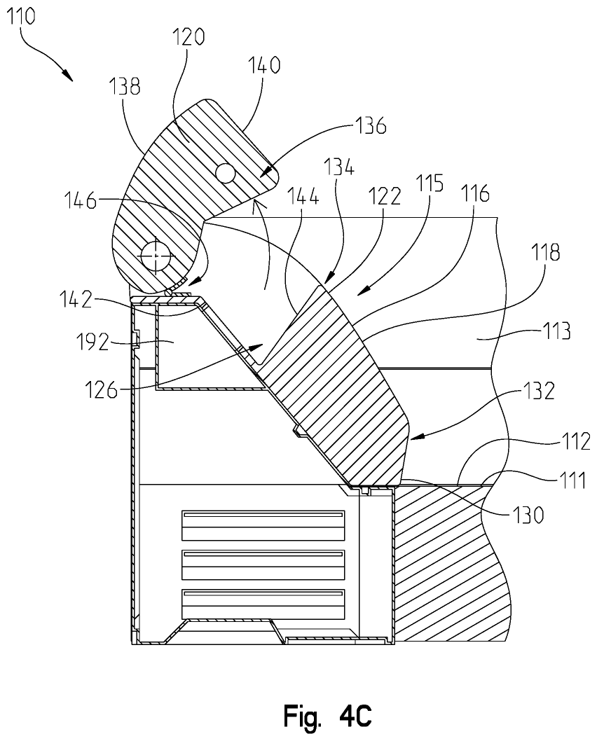

In the first position, at least a portion 136 of the supplemental support 120 may be positioned lower than the upper extent 134 of the main support (see FIG. 3B). In the second position, the at least a portion 136 of the supplemental support 120 may be positioned higher than the upper extent 134 of the main support 118 (see FIG. 4B). For example, the portion 136 may be at a first height when the supplemental support 120 is in the first position and the portion 136 may be at a second height that is different than the first height when the supplemental support 120 is in the second position. The portion 136 may be translated and/or rotated from the first height to the second height (e.g., with respect to the main support 118).

In the first configuration or first position, a first segment or portion 138 of the supplemental support 120 may form part of the forward passenger support interface 116. In the second configuration or second position, a second segment or portion 140 of the supplemental support 120 may form part of the forward passenger support interface 116.

For example, the supplemental support 120 may be rotatable between the first position (see FIGS. 2A and 3B) and the second position (see FIGS. 2B and 4B), with respect to the main support 118. In the first position, the first segment 138 of the supplemental support may be forward facing (e.g., with respect to the forward passenger support interface 116), while the second segment 140, may be downward facing (e.g., disposed within the recess 126). Comparatively, in the second position, the first segment 138 may be upward facing, while the second segment 140 may be forward facing (e.g., with respect to the forward passenger support interface 116).

Additionally or alternatively, in some examples, the supplemental support 120 may be translatable between the first position and the second position. For example, the supplemental support 120 may have an upper forward facing portion (not shown) that forms part of the forward passenger support interface 116 in the first position. The supplemental support 120 may also have a lower forward facing portion (not shown) that is elevated in the second position, relative to the first position, to form part of the forward passenger support interface 116 when the supplemental support 120 is in the second position.

FIG. 3A illustrates a right-side view of the passenger seat 110 of FIG. 2A, in the first configuration, and FIGS. 3B and 3C illustrate a right-side, cross-sectional view of the passenger seat 110 of FIG. 2A, in the first configuration. As shown in, for example, FIG. 3B, the main support 118 defines a recess 126. At least a portion of the supplemental support 120 is received in the recess 126 of the main support 118 in the first configuration. Comparatively, the portion of the supplemental support 120 is spaced apart from the recess 126 in the second configuration (e.g., as shown in FIGS. 4A and 4B).

The recess 126 may extend at least partially between the top edge 128 and the bottom edge 130 of main support 118. Therefore, when the supplemental support 120 is in the first position, at least a portion of the supplemental support 120 is disposed between the top edge 128 and the bottom edge 130 of the main support 118.

In the first position, the supplemental support 120 forms a back support (e.g., backrest). For example, the supplemental support 120 may form a back support at the first segment 138. In some examples, a passenger who sits on the passenger seat 110 may support their back on the supplemental support 120 when it is in the first position. In some examples, an outward facing surface of the supplemental support 120, such as first segment 138, forms a continuous surface with the forward passenger support interface 116 of the main support 118.

FIG. 4A illustrates a right-side view of the passenger seat 110 of FIG. 2A, in the second configuration. In the second configuration, the supplemental support 120 is in the second position. It should be noted that while the second position of the supplemental support 120 is shown to be a fixed location in the illustrated example, one of ordinary skill in the art should recognize that the location of the second position may be adapted to a different height and/or distance with respect to the main support, such as by a user and/or manufacturer, for specific use-cases.

In some examples, in the second position, the supplemental support 120 forms a head support (e.g., a headrest). For example, the second segment 140 of the supplemental support 120 may form a head support. In some examples, a passenger who sits on the passenger seat 110 may sit more erect and support their head on the supplemental support 120 when it is in the second position as opposed to when supplemental support 120 is in the first position. In some examples, the portion of the supplemental support 120 that supports a passengers head may be sized and shaped to receive the passengers head. For example, the portion of the supplemental support 120 that supports a passengers head may be curved inward toward a center of the supplemental support to provide a curvature that supports the curvature of a passengers head.

In some examples, the supplemental support 120 includes at least one of a strap, a grip, or a handle to assist a user in moving the supplemental support 120 between the first position and the second position (e.g., from the first position to the second position, or vice-versa). The strap, grip, and/or handle may be disposed along a surface of the supplemental support 120 that defines the back support when in the first position and/or a surface of the supplemental support 120 that defines the head support when in the second position. Additionally and/or alternatively, at least one of the strap, grip, and/or handle may be disposed anywhere along the supplemental support 120 such that a person can use the strap, grip, and/or handle to move the supplemental support 120 between the first position and the second position.

In some examples, the supplemental support 120 may be configured to automatically move from the first position to the second position. For example, the passenger seat 110 may include a controller (not shown), a power source (not shown), and a movement mechanism, such as a motor, pneumatic cylinder, hydraulic cylinder, etc. that are configured to move the supplemental support 120 between the first position and the second position. In some examples, an indication may be received (e.g., from an operator in the operator seat, from a person sitting on the passenger seat 110, etc.) in response to which the supplemental support moves between the first position and the second position. Further, in some examples, the supplemental support 120 may be configured to move between the first position and the second position via spring loaded forces. Additional and/or alternative techniques for moving the supplemental support 120 between the first position and the second position will be recognized by those of ordinary skill in the art at least in light of teachings provided herein.

FIGS. 4B and 4C illustrate a right-side, cross-sectional view of the passenger seat 110 in the second configuration, according to some aspects described herein. As shown in, for example, FIG. 4B, the recess 126 may be formed by a void or cutout within the main support 118. For example, the recess may be formed between a first internal wall 142 and a second internal wall 144 of the main support 118. The first internal wall 142 and the second internal wall 144 may be angled with respect to each other such that the recess 126 is generally triangular in shape. In some examples, the recess 126 may be generally cylindrical, or generally prismatic, or any other shape that may be recognized by those of ordinary skill in the art.

Further, while the illustrated example forms the recess 126 between two angled walls (e.g., the first internal wall 142 and the second internal wall 144) it is possible that the recess 126 may be formed between any number of walls (or even a single curved wall) such that the recess 126 may be sized and shaped as desired for specific use cases that will be recognized by those of ordinary skill in the art.

In some examples, the recess 126 may include one or more charging ports (not shown), such as may be disposed in the first internal wall 142 and/or the second internal wall 144. In some examples, a display screen (not shown) may be stored in the recess 126, such as a display screen for a computing device. In some examples, a trash can 190 (see FIG. 4B) and/or a recycling bin (not shown) may be accessible through recess 126, such as through an opening in wall 142. In some examples, one or more cup holders (not shown) may be disposed in the recess 126. Generally, the recess 126 may be adapted to store one or more components, as will be recognized by those of ordinary skill in the art, depending on desired implementations.

As shown in FIGS. 3C and 4C, in some examples, the passenger seat 110) includes a storage unit or container 192. The storage unit 192 may be accessible through the recess 126, such as when the supplemental support 120 is in an upward or lifted configuration. For example, the recess 126 may be in fluid connection with the storage unit 192, such as through a cutout in the first internal wall 142. The storage unit 192 may be formed integral to the seat back 115. Alternatively, the storage unit 192 may be removably coupled to the seat back 115. The storage unit 192 may be disposed opposite of the forward passenger support interface 116 (e.g., with respect to the main support 118). In some examples, the passenger seat 110 includes the storage unit 192 instead of the trash can 190. In some examples, the passenger seat 110 includes the storage unit 192 in addition to the trash can 190. Further, some examples may include neither of the trash can 190 or the storage unit 192.

In some examples, the passenger seat 110 includes one or more hinges 146 by which the supplemental support 120 is coupled to the main support. The supplemental support 120 may rotate about the hinges 146 when moved between the first position and the second position. Additionally, or alternatively, the supplemental support may be translated via the hinges (e.g., vertically). In some examples, the hinges 146 are one of friction hinges, detent hinges, and/or telescope hinges. Further, in some examples, the hinges 146 are rotary hinges with a single pin location and plates that rotate about the single pin location.

In examples where the hinges 146 are friction hinges, the supplemental support 120 may be configured to move to any position (e.g., any of a continuous number of positions) between a fully-down position (e.g., the first position) and a fully-raised position (e.g., the second position). In examples where the hinges 146 are detent hinges, the supplemental support 120 may be configured to rotate to any of a fixed number of positions between a fully-down position (e.g., the first position) and a fully-raised position (e.g., the second position). The fixed number of positions may include a single raised position (e.g., the fully-raised position), two raised positions, three raised positions, four raised positions, or any other number of raised positions that may be desirable for specific use-cases.

In some examples, one of the supplemental support 120 and the main support 118 include rods (not shown) and the other one of the supplemental support 120 and the main support 118 include holes (not shown) that are sized and shaped to receive the rods. The supplemental support 120 may move between the first position and the second position via adjustment of a height of the rods with respect to the holes.

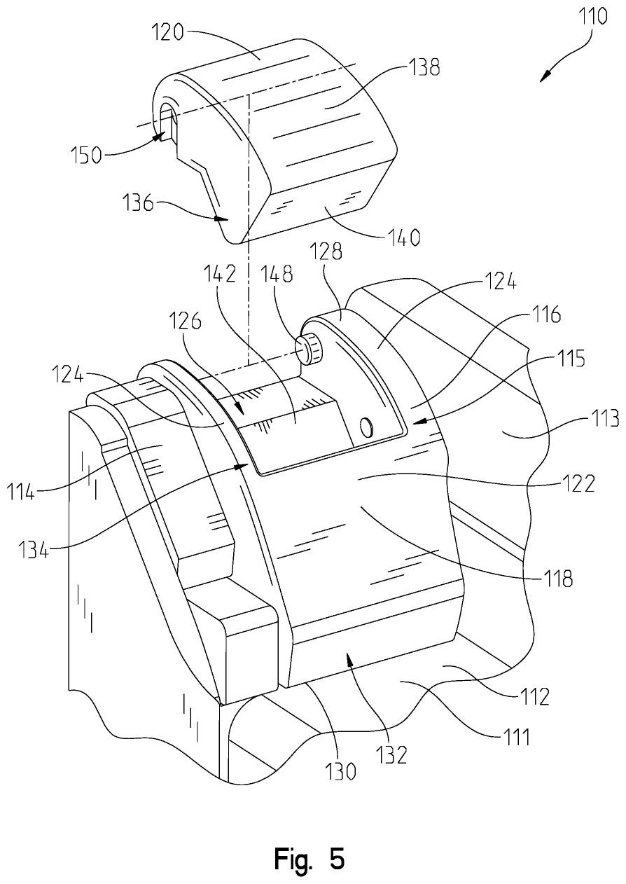

FIG. 5 illustrates an exploded view of components of the passenger seat 110, according to some aspects described herein. In some examples, the supplemental support 120 may be coupled directly to the main support 118. In the example of FIG. 5, the main support 118 includes one or more protrusion 148 and the supplemental support 120 includes one or more slots 150 that are sized and shaped to receive the one or more protrusions 148, thereby coupling the supplemental support 120 to the main support 118. The slots 150 and/or protrusions 148 may define an axis of rotation about which the supplemental support 120 rotates.

In some examples, the supplemental support 120 may be directly coupled to the main support 118 via one or more mechanical fasteners that still allow for rotation and/or translation of the supplemental support 120 with respect to the main support 118. In some examples, the supplemental support 120 may be directly coupled to the main support via the one or more hinges 146 (see FIG. 4B).

In some examples, the supplemental support 120 may be indirectly coupled to the main support 118. For example, an intermediary plate or component (not shown) may be coupled to the main support 118, and the supplemental support 120 may be coupled to the intermediary plate. In some examples, an intermediary plate or component (not shown) may be disposed adjacent to the main support 118 (but not coupled thereto), and the supplemental support 120 may be coupled to the intermediary plate to rotate and/or translate with respect to the main support 118.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A seat for a boat passenger, the seat comprising:
a seat back having a forward passenger support interface, the seat back comprising:
a main support having a recess, and
a supplemental support movable relative to the main support between a first position wherein a first portion of the supplemental support forms part of the forward passenger support interface and a second position wherein a second portion of the supplemental support forms part of the forward passenger support interface, wherein at least a portion of the supplemental support is received in the recess of the main support in the first position and is spaced apart from the recess in the second position.

2. The seat of claim 1, further comprising:
a seat bottom having an upper passenger support interface sized and shaped to support legs and feet of the boat passenger.

3. The seat of claim 1, wherein the main support comprises a center portion, and laterally opposed support members, the center portion extending between the laterally opposed support members, and the recess being formed between the laterally opposed support members.

4. The seat of claim 3, wherein the main support defines a top edge and a bottom edge, and wherein the recess extends at least partially between the top edge and the bottom edge of the main support.

5. The seat of claim 1, wherein the supplemental support is rotatable between the first position and the second position, with respect to the main support.

6. The seat of claim 5, further comprising hinges, by which the supplemental support is coupled to the main support, and about which the supplemental support rotates.

7. The seat of claim 6, wherein the hinges are one of friction hinges or detent hinges.

8. The seat of claim 1, wherein the supplemental support is translatable between the first position and the second position.

9. The seat of claim 1, wherein the supplemental support comprises at least one of a strap, a grip, or a handle.

10. A seat for a boat passenger, the seat comprising:
a seat bottom having an upper passenger support interface sized and shaped to support legs and feet of the boat passenger; and
a seat back having a forward passenger support interface, the seat back comprising:
a main support having a lower extent and an upper extent, and
a supplemental support movable relative to the main support between a first position, wherein a first portion of the supplemental support is positioned lower than a top edge of the upper extent of the main support, and a second position, wherein the first portion of the supplemental support is positioned higher than the upper extent of the main support.

11. The seat of claim 10, wherein the main support comprises a center portion, and laterally opposed support members, the center portion extending between the laterally opposed support members, and a recess being formed between the laterally opposed support members.

12. The seat of claim 11, wherein the main support further includes a bottom edge, and wherein the recess extends at least partially between the top edge and the bottom edge of the main support.

13. The seat of claim 10, wherein the supplemental support is rotatable between the first position and the second position, with respect to the main support.

14. The seat of claim 13, further comprising hinges, by which the supplemental support is coupled to the main support, and about which the supplemental support rotates, the hinges being one of friction hinges or detent hinges.

15. The seat of claim 10, wherein the supplemental support is translatable between the first position and the second position.

16. A seat for a boat passenger, the seat comprising:
a seat bottom having an upper passenger support interface sized and shaped to support legs and feet of the boat passenger; and
a seat back having a forward passenger support interface, the seat back comprising:
a main support, and
a supplemental support movable relative to the main support between a first position wherein the supplemental support forms a back support and a second position wherein the supplemental support forms a head support.

17. The seat of claim 16, wherein the main support comprises a center portion, and laterally opposed support members, the center portion extending between the laterally opposed support members, and a recess being formed between the laterally opposed support members.

18. The seat of claim 17, wherein the main support defines a top edge and a bottom edge, and wherein the recess extends at least partially between the top edge and the bottom edge of the main support.

19. The seat of claim 16, wherein the supplemental support is rotatable between the first position and the second position, with respect to the main support.

20. The seat of claim 16, wherein the supplemental support is translatable between the first position and the second position.
